(19) United States
(12) Patent Application Publication
(10) Pub. No.: US 2005/0018257 A1
(43) Pub. Date: Jan. 27, 2005

(54) Method and apparatus for imaging transparency sheet media

(76) Inventors: Eric L. Andersen, Meridian, ID (US); Paul K. Mui, Boise, ID (US); Russell A. Mendenhall, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/623,746

(22) Filed: Jul. 21, 2003

(51) Int. Cl. H04N 1/04; H04N 1/46

(52) U.S. Cl. 358/506; 358/498

(57) ABSTRACT

A system including a user computer is configured to generate an electronic document file, and an imaging apparatus is configured to form mirror images on a side of a transparency media in correspondence to the electronic document file. The system also includes an overhead projector configured to support the transparency media with the imaged side in contact with the overhead projector, and to project the mirror images in proper viewing orientation onto a surface. A method of imaging transparency sheet media includes detecting a transparency media designation associated with an electronic document file, and determining a mirror imaging status in response to detecting the transparency media designation. The method further includes deriving an electronic mirror image corresponding to the electronic document file in accordance with the status, and forming an image on a sheet of transparency sheet media in accordance with the electronic mirror image.

### BACKGROUND

Various kinds of presentation methods and devices are used to visually impart information to an audience or group of viewers. Among these are video presentation devices, film stripes, photographic slide presentations, whiteboards, chalkboards, etc. In particular, one known method is the use of an overhead projector in conjunction with one or more sheets of image-bearing transparency media.

One way of producing an image on transparency media is the use of an imaging apparatus (e.g., a laser printer) coupled to a computer. Typically, the computer is used to generate an electronic document file, which is thereafter transmitted to a printer for imaging on transparency media. Once the transparency media are prepared (i.e., printed) they are ably transported from place to place and are readily usable and reproducible without further reliance on the computer or imaging apparatus.

However, the printing of transparency media sometimes results in a generally undesirable curling or bending of the sheet media edges. This curling, in turn, can lead to unsatisfactory or illegible projected images as a result of the transparency sheet media failing to lie flat upon the overhead projector platen. Furthermore, users often resort to the use of paperweights or other objects in an attempt to flatten the transparency in uniform contact with the projector platen. Such efforts are generally undesirable, inconvenient and largely unsuccessful.

Therefore, it is desirable to provide methods and apparatus for use in conjunction with transparency sheet media that address the problems described above.

### SUMMARY

One embodiment provides for a method of imaging transparency sheet media, including the steps of detecting a transparency media designation associated with an electronic document file, and then determining a mirror imaging status in response to detecting the transparency media designation. The method further includes deriving an electronic mirror image corresponding to the electronic document file in accordance with the status, and forming an image on a sheet of transparency sheet media in accordance with the electronic mirror image.

Another embodiment provides for a computer-accessible storage media. The computer-accessible storage media includes an executable program code configured to cause a processor to detect a transparency media designation associated with an electronic document file. The program code is further configured to cause the processor to determine a mirror imaging status in response to detecting the transparency media designation, and then to derive an electronic mirror image of the electronic document file in accordance with the status. The electronic mirror image is then transmitted to an imaging apparatus.

Yet another embodiment provides for a system including a user computer configured to generate an electronic document file. The system further includes an imaging apparatus coupled to the user computer. The imaging apparatus is configured to form mirror images on a side of a transparency sheet media in correspondence to the electronic document file, thus defining a mirror-imaged media. The system further includes an overhead projector configured to support the mirror-imaged media with the imaged side in contact with the overhead projector. Furthermore, the overhead projector is configured to viewably project the mirror images in proper viewing orientation onto a surface.

These and other aspects and embodiments will now be described in detail with reference to the accompanying drawings, wherein:

### DESCRIPTION OF THE DRAWINGS

FIG. 1 is a perspective view depicting an image projection system according to the prior art.

FIG. 2 is a block diagram depicting an imaging system in accordance with an embodiment of the present invention.

FIG. 3 is a perspective view depicting an image projection system in accordance with another embodiment of the present invention.

FIG. 4 is a flowchart depicting a method in accordance with still another embodiment of the present invention.

### DETAILED DESCRIPTION

In representative embodiments, the present teachings provide methods and apparatus for forming mirror images on transparency sheet media for use with an overhead projector system.

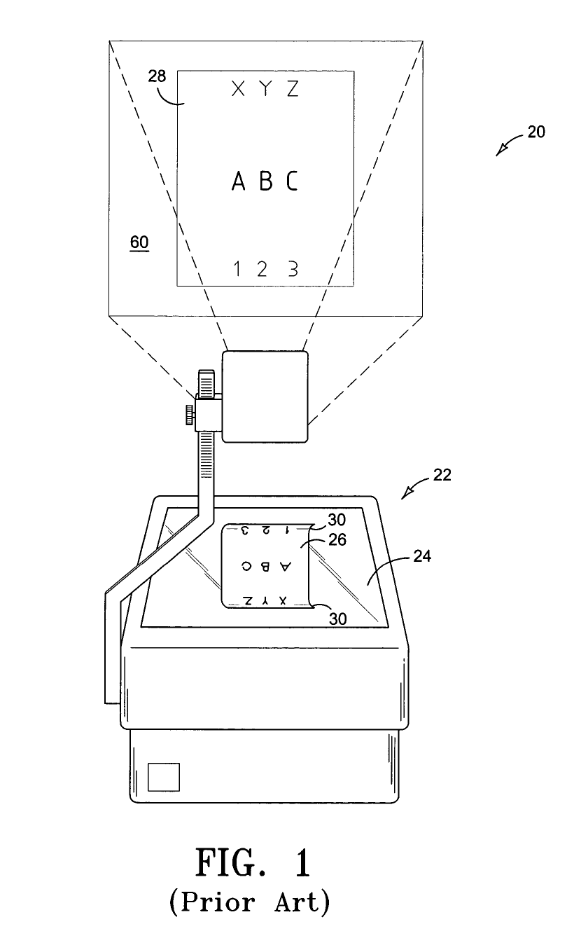

Turning now to FIG. 1, a perspective view depicts a system 20 for projecting a sheet media image according to the prior art. System 20 includes an overhead projector 22 typically configured to support a transparency media on a glass platen (hereafter, platen) 24. As depicted in FIG. 1, the system 20 also includes an image-bearing transparency media 26 that is supported on the platen 24. As further depicted in FIG. 1, the overhead projector 22 is projecting the image content of the transparency media 26 as a projected image 28 on a surface 60, which is generally viewable by a number of observers (i.e., conference participants, etc.).

For purposes herein, it is assumed that the transparency media 26 has been imaged by way of a suitable imaging apparatus (e.g., laser printer). As a result of the imaging process, the transparency media 26 includes a characteristic curling 30 at the media 26 edges. The curling 30 results in corresponding portions of the transparency media 26 lifting away from the platen 24. This lifting away typically results in an out-of-focus or illegible condition within the projected image 28 corresponding to the image content of the transparency media 26 affected by the curling 30.

As depicted in FIG. 1, the transparency media 26 includes image contents “XYZ” and “123” that are located within respective portions of the transparency media 26 affected by the curling 30, resulting in generally out-of-focus or blurred corresponding images within the projected image 28. In contrast, the transparency media 26 further includes image content “ABC” that is generally centrally located on the media 26 and is therefore substantially unaffected by the curling 30. As such, the corresponding image “ABC” is generally well-focused (i.e., clearly legible) within the projected image 28.

In an attempt to correct for the effects of the curling 30, users have traditionally resorted to the use of pens, staplers and other objects (not shown) as weights to maintain the transparency media 26 in uniform contact with the overhead projector platen 24. Generally, such efforts are distracting to observers, inconvenient to the presenter (i.e., projector user) and tend to obscure portions of the projected media image 28 content. Alternatively, users have sometimes attempted to correct the out-of-focus areas of the projected image 28 by adjusting the overall focus to a compromise or “average” setting, with the result that none of the projected image 28 content is clearly defined. In any case, it is desirable to provide for the projection of imaged transparency media that substantially avoids the problems described above.

Methods and apparatus in accordance with the present invention are described hereafter.

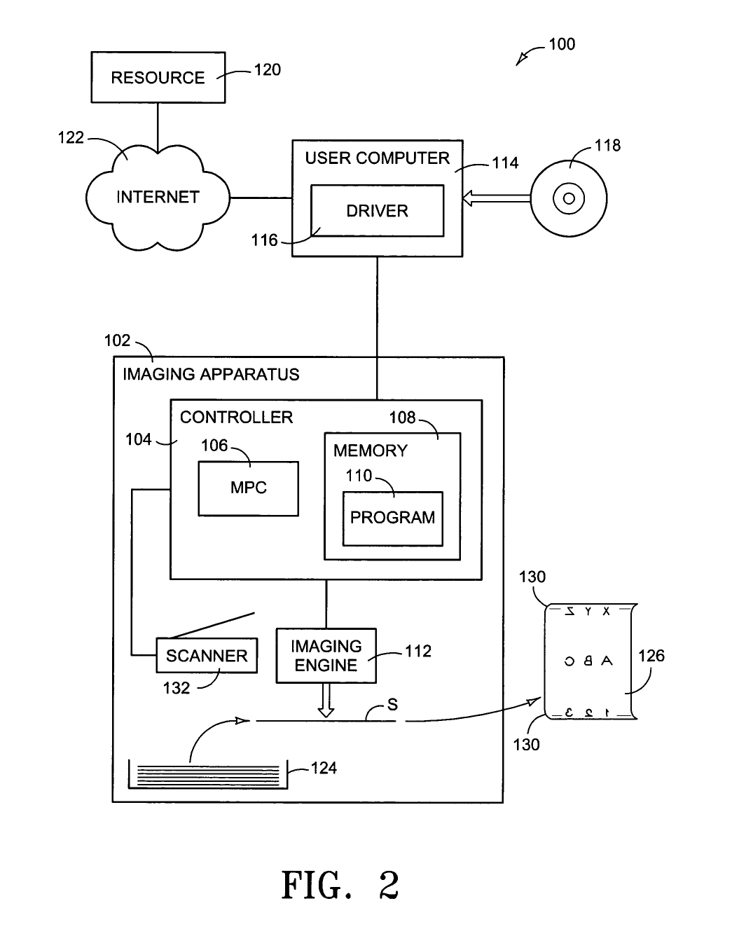

FIG. 2 is a block diagram depicting an imaging system 100 in accordance with an embodiment of the present invention. The imaging system 100 includes an imaging apparatus 102. The imaging apparatus 102 includes a controller 104. As depicted in FIG. 2, the controller 104 includes a processor 106 and a memory (i.e., computer-accessible storage media) 108. The memory 108 includes an executable program code 110. The program code 110 is generally configured to cause the processor 106 to control any number of normal operations of the imaging apparatus 102. Such normal operations are described in detail hereafter.

One of skill in the electronic control arts can appreciate that other embodiments (not shown) of the controller 104 can also be defined and used as required and/or desired and can include, for example: analog, digital and/or hybrid electronic circuitry; state machines; dedicated-purpose integrated circuits; a microcontroller or other processor; etc. Further elaboration of the controller 104 is not required for purposes of understanding the instant invention.

The imaging apparatus 102 also includes an imaging engine 112. The imaging engine 112 can include any such suitable device configured to selectively form images on sheet media (including, in particular, transparency sheet media) under the signal control of the controller 104. Non-limiting examples of such an imaging engine 112 include a laser imaging engine, an inkjet imaging engine, etc. Other suitable kinds of imaging engine 112 can also be used in accordance with the present invention.

As depicted in FIG. 2, the imaging apparatus 102 also includes an (optional) scanner 132. The scanner 132 is coupled in signal communication with the controller 104. The scanner 132 is generally configured to provide an electronic image (i.e., electronic document file) to the controller 104 representing the image content of a sheet of media (not shown) that is optically scanned, or read, by the scanner 132. Thus, the imaging apparatus 102 can be considered to be a multi-function printer (MFP) type of apparatus. One of skill in the related arts can appreciate that various other embodiments (not shown) of the imaging apparatus 102 can also be used, in which the scanner 132 is not included.

The imaging apparatus 102 can also include any number of other suitable elements and/or devices (not shown) as required or desired for normal operation. Such elements and devices (not shown) can include, for example: a power supply; input-output circuitry; a user interface; reservoirs of toner, ink, or other consumables; etc. Therefore, particular embodiments of the imaging apparatus 102 can be defined by any suitable cooperative assemblage of such elements and devices in accordance with the present invention.

The imaging system 100 also includes a user computer 114. The user computer 114 is coupled in data communication with the imaging apparatus 102. The user computer 114 includes a driver program code (hereafter, driver) 116. The driver 116 is configured to be run by the user computer 114 during the preparation and communication of data between the user computer 114 and the imaging apparatus 102 in accordance with the present invention. As such, the driver 116 provides for such operations as, for example: prompting the user for various inputs regarding the use of the imaging apparatus 102; setting various designations (i.e., imaging parameters) associated with an electronic file (i.e., data) being communicated to the imaging apparatus 102 for imaging on sheet media; deriving electronic information or images corresponding to some or all of an electronic file content; etc. Other operations regarding the handling, translation, and/or derivation of electronic files (data) communicated between the user computer 114 and the imaging apparatus 102 can also be provided by way of the driver 116.

As depicted in FIG. 2, the driver 116 can be provided to the user computer 114 in a number of suitable ways such as, for example, as program content on a compact disc 118, or in the form of a download obtained from a resource 120 coupled to the user computer 114 by way of the Internet 122. In one embodiment, the driver 116 is provided with other program content (not shown) used with the user computer 114, such as, for example, in conjunction with an operating system. One of skill in the computing arts can appreciate that a variety of suitable ways can be used to provide the driver 116 to the user computer 114, and that further elaboration of such ways and devices is not required for purposes herein.

Typical operation of the imaging system 100 is generally as follows: the user computer 114 is used to generate an electronic document file, commonly referred to as a print job. The user computer 114 then invokes the driver 116 for purposes of communicating the electronic document file to the imaging apparatus 102 for imaging on sheet media. For purposes of example, it is assumed that the content of the electronic document file is to be imaged on transparency media and that a corresponding designation has been associated with (i.e., set or flagged within) the electronic document file by the driver 116 in response to a corresponding user input.

In response to the transparency media designation, the driver 116 prompts a user (not shown) of the user computer 114 to select either normal (i.e., conventional) imaging, or mirror imaging of the electronic document file on transparency media. For ongoing purposes of example, it is assumed that the user input corresponds to mirror imaging of the electronic document file.

In response to the mirror imaging selection, the driver 116 then derives an electronic mirror image corresponding to the content of the electronic document file. Such a mirror image can be derived, for example, by transposing image elements (bits, or pixels) about some predetermined line of symmetry, usually a vertical centerline of each sheet defined by the electronic document file (described in further detail hereafter). Other suitable methods of deriving the mirror image can also be used. In any case, the driver 116 then causes the electronic mirror image to be communicated to the controller 104 of the imaging apparatus 102, along with an associated transparency media designation.

The controller 104 then causes a sheet of transparency media “S” to be drawn from an input tray 124 and routed to the imaging engine 112 by way of a suitable transporting and routing mechanism. The controller 104 then causes the imaging engine 112 to image one side of the transparency media S in accordance with the electronic mirror image. The imaged sheet of media is then routed away from the imaging engine 112 and generally out of the imaging apparatus 102, as a mirror-imaged transparency media 126 bearing a mirror image of each of the original electronic document file image contents “XYZ”, “ABC” and “123”, respectively.

The process described above is typically repeated, one sheet of media at a time, until all of the content of the electronic document file has been correspondingly mirror-imaged on sheets of transparency media S. Is to be understood that multiple media input trays (not shown; e.g., input tray 124) can be used in corresponding embodiments of the imaging apparatus 102 such that sheet media can be selectively drawn from them in accordance with the pending print job.

In a typical alternative operation, the scanner 132 is used to optically scan the image content of a sheet media (not shown) to produce a corresponding electronic document file for imaging on transparency media S. Under such an alternative operation, a user selects (i.e., designates) transparency media and either normal or mirror imaging by way of a suitable user interface (not shown) coupled to the controller 104 of the imaging apparatus 102. That is, a user interface (not shown) can be used to associate both a transparency media designation and a mirror imaging status with the electronic document file resulting from the optical scanning operation performed by the scanner 132. Such user selections and/or designations can either be assertive (i.e., input directly upon activation of the scanning operation) or provided in response to prompting a user via a user interface (not shown).

Thus, mirror imaged transparencies (e.g., mirror imaged transparency media 126) can be created on a generally casual “walk up” basis, readily permitting the generation of mirror imaged transparencies from existing documents or other transparencies. Other typical operations corresponding to other embodiments of the imaging apparatus 102 can also be used.

As depicted in FIG. 2, the mirror-imaged sheet media 126 includes curling 130 near what were typically the leading and trailing edges of the sheet media S as it was imaged by the imaging engine 112, including those areas of the sheet media 126 generally bearing the mirror-imaged content “XYZ” and “123”, respectively. Other forms of edge curling (not shown) can also occur. Generally, such curling 130 occurs, for example, as a result of fusing toner to the media S in the case of laser-type imaging engine 112, or as a result of the heat of drying an imaging substance applied to the sheet media S in the case of an inkjet imaging engine 112. In any event, the curling 130 is assumed to cause a general concavity of the sheet media 126 in the direction of the image-bearing side (i.e., toward the mirror-image content “ABC”, etc.).

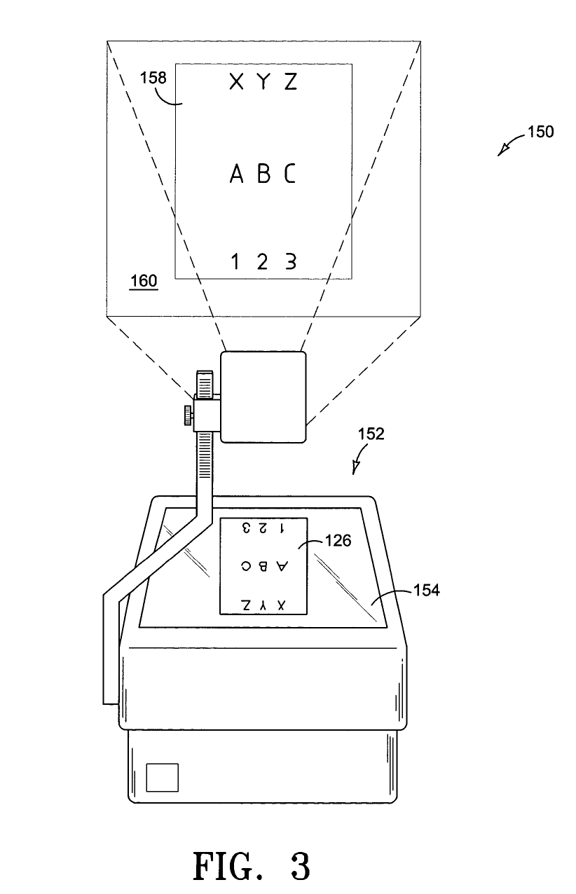

Typical usage of the mirror-imaged sheet media 126 is described hereafter in regard to FIG. 3.

In another embodiment of the imaging system 100, the driver 116 is configured to receive an input (i.e., a user input, etc.) designating an automatic mirror-imaging. In this way, an electronic mirror image is automatically derived by the driver 116 for each electronic document file designating transparency media that is handled while the automatic mirror-imaging designation is in effect. The derivation and communication of the electronic mirror image from the user computer 114 to the controller 104 of the imaging apparatus 102 is thus automatically performed by the driver 116 without the need to prompt a user to select either normal or mirror imaging for each particular electronic document file designated for imaging on transparency media S. This kind of automatic mirror-imaging designation or “default” setting tends to save processing time and spares the user from a generally tedious and repetitive selection burden. Such a default setting can be pre-selected (i.e., preset) within the driver 116 and/or controller 104 as a result, for example, of anticipating transparency media curling problems.

In still another embodiment of the imaging system 100, the driver 116 is configured to receive an input (i.e., user input) designating transparency media to be associated with an electronic document file. The electronic document file, along with its associated transparency media designation, is then communicated from the user computer 114 to the controller 104 of the imaging apparatus 102. The program code 110 of the controller 104 then causes the processor 106 to detect the transparency media designation of the just-received electronic document file. In response to such a detecting, the processor 106 then either: 1) causes a user (not shown) of the user computer 114 to be prompted to select either normal or mirror imaging; or 2) detects an automatic mirror-imaging designation associated with the electronic document file. The processor 106 then derives an electronic mirror image of the electronic document file (or not) in accordance with the selection or the detecting.

In turn, the controller 104 causes the transparency media S to be imaged accordingly (mirror or normal imaged). In such an embodiment, the program code 110 causes the processor 106 (i.e., controller 104) to handle a relatively greater portion of the mirror-imaging process (selection, detection, derivation, etc.) than described above in regard to the other embodiments of the imaging system 100. Other embodiments of the imaging system 100 including varying ‘divisions of labor’ between the driver 116 and the processor 106 can also be used in accordance with the teachings of the present invention.

FIG. 3 is a perspective view depicting an image projecting system 150 in accordance with another embodiment of the present invention. The projecting system 150 includes an overhead projector 152. The overhead projector 152 includes a transparent, substantially planar support area (hereafter, platen) 154. The platen 154 is generally configured to support transparency media during projection of the image content thereon.

As depicted in FIG. 3, the platen 154 supports the mirror-imaged media 126 described above. In particular, the mirror-imaged media 126 is supported with the image-bearing side in contact with the platen 154 (i.e., imaged-side down). In this configuration, the mirror-imaged contents “XYZ”, “ABC” and “123” of the media 126 appear in their normal viewing orientations from an observation point (not shown) located above the platen 154.

As also depicted in FIG. 3, the influence of gravity serves to generally flatten and maintain the mirror-imaged media 126 in substantially uniform contact with the platen 154. In this way, the image contents “XYZ”, “ABC” and “123” of the media 126 appear in their normal (i.e., proper viewing) orientations within a projected image 158 on a surface (i.e., projection screen) 160. Furthermore, the image contents “XYZ”, “ABC” and “123” are all substantially well-focused and legible within the projected image 158, without the generally inconvenient and distracting use of various items (i.e., pens, staplers, etc.) to serve as “paperweights” during the projection process and/or associated presentation. Other embodiments (not shown) of the projecting system 150 can also be used in accordance with the present invention.

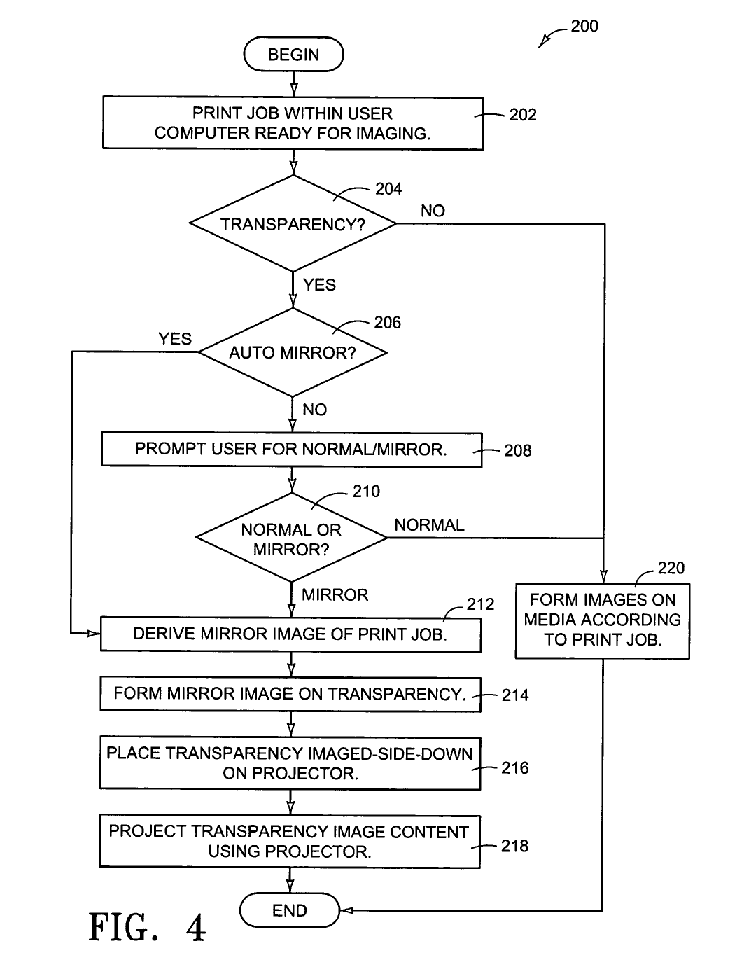

FIG. 4 is flowchart depicting a method 200 in accordance with still another embodiment of the present invention. In the interest of clarity of understanding, the method 200 is described with reference to the imaging system 100 of FIG. 2 and the image projecting system 150 of FIG. 3. However, it is to be understood that the method 200 is generally applicable to any embodiment of apparatus of the present invention. While the method 200 includes particular steps and order of execution, other methods can respectively including other steps and order of execution can also be used in accordance with the present invention.

In step 202 (FIG. 4), an electronic document file (i.e., print job) within the user computer 114 (FIG. 2) is ready for imaging by the imaging apparatus 102.

In step 204 (FIG. 4), it is determined if the print job calls for imaging on transparency media S (FIG. 2). Such a determination can be performed by either the user computer 114 under the control of the driver 116, or by the processor 106 under the control of the program code 110, in accordance with the particular embodiment of the imaging system 100. In any case, the determination is made in conjunction with detecting a transparency media designation associated with the print job. If a transparency designation is detected, then the method 200 (FIG. 4) proceeds on to step 206. If no transparency designation is detected, then the method 200 proceeds on to step 220.

In step 206 (FIG. 4), it is determined if an automatic mirror imaging designation is associated with the print job. This determination can be performed by either the user computer 114 (FIG. 2) by way of the driver 116, or by the processor 106 under the control of program code 110, in accordance with the particular imaging system 100. If automatic mirror imaging is detected, then the method 200 (FIG. 4) proceeds to step 212. If automatic mirror imaging is not detected, then the method 200 proceeds on to step 208.

In step 208 (FIG. 4), a user is prompted by way of the user computer 114 (FIG. 2) to select normal imaging or mirror imaging in regard to the pending print job. This prompting can be performed under the control of either the program code 110 or the driver 116, or as a cooperative effort of the two, in accordance with the embodiment of the imaging system 100.

In step 210 (FIG. 4), the user response to the prompting of step 208 above is evaluated. If the user response (i.e., input) selects normal imaging, then the method 200 (FIG. 4) proceeds on to step 220. If the user selects mirror imaging, then the method 200 proceeds on to step 212.

In step 212 (FIG. 4) an electronic mirror image is derived corresponding to the print job image content. The electronic mirror image can be derived by either the user computer 114 (FIG. 2) under the control of the driver 116, or by the processor 106 under the control of the program code 110, in accordance with the embodiment of the imaging system 100. In the case where the derivation is performed by the user computer 114, the electronic mirror image is then transmitted to the controller 104 of the imaging apparatus 102. In the case where the derivation is performed by the processor 106, the electronic mirror image is inherently present within the controller 104.

In step 214 (FIG. 4), the processor 106 (FIG. 2) causes the imaging engine 112 to form images on the transparency media S in accordance with the electronic mirror image derived in step 212 above, resulting in the mirror-imaged media 126. The resulting mirror-imaged media 126 is then suitably discharged from the imaging apparatus 102.

In step 216 (FIG. 4), the mirror-imaged media 126 (FIG. 3) is placed imaged-side-down on the platen 154 of the overhead projector 152 by a user (not shown).

In step 218 (FIG. 4), the content of the mirror-imaged media 126 (FIG. 3) is as a viewable projected image 158. The image content “XYZ”, “ABC” and “123” is substantially well-focused and clearly legible within the projected image 158. A single instance of the method 200 (FIG. 4) is now considered complete.

In step 220 (FIG. 4), any print job readied within the user computer 114 (FIG. 2) does not call for (i.e., designate) transparency media, and thus is imaged by the imaging apparatus 102 on conventional sheet media (i.e., paper, etc.). The method 200 is now considered complete.

While the above methods and apparatus have been described in language more or less specific as to structural and methodical features, it is to be understood, however, that they are not limited to the specific features shown and described, since the means herein disclosed comprise preferred forms of putting the invention into effect. The methods and apparatus are, therefore, claimed in any of their forms or modifications within the proper scope of the appended claims appropriately interpreted in accordance with the doctrine of equivalents.

1. A method of imaging transparency sheet media, comprising:
detecting a transparency media designation associated with an electronic document file;
determining a mirror imaging status in response to detecting the transparency media designation;
deriving an electronic mirror image corresponding to the electronic document file in accordance with the status; and
forming an image on a sheet of transparency sheet media in accordance with the electronic mirror image.

2. The method of claim 1, and further comprising receiving the electronic document file from a user computer.

3. The method of claim 1, and further comprising receiving the electronic document file from an optical scanner.

4. The method of claim 1, and wherein determining the mirror imaging status includes detecting an automatic mirror imaging designation associated with the electronic document file.

5. The method of claim 1, and wherein determining a mirror imaging status includes receiving a user input designating one of a normal imaging or a mirror imaging.

6. A method of projecting an image, comprising:
providing a sheet of transparency sheet media defined by a first side;
providing a projector having a platen;
forming a mirror image on the first side of the transparency sheet media;
placing the first side of the transparency sheet media in contact with the platen; and
projecting the image.

7. The method of claim 6, and wherein forming the mirror image includes forming the mirror image on the first side of the transparency sheet media in correspondence to an electronic document file.

8. The method of claim 6, and wherein projecting the image includes projecting the image in proper viewing orientation onto a screen.

9. A computer-accessible storage media including an executable program code, the program code configured to cause a processor to:
detect a transparency media designation associated with an electronic document file;
determine a mirror imaging status in response to detecting the transparency media designation;
derive an electronic mirror image of the electronic document file in accordance with the status; and
transmit the electronic mirror image to an imaging apparatus.

10. The computer-accessible storage media of claim 9, and wherein the computer-accessible storage media includes one of a compact disk, a magnetic disk, or a solid state memory.

11. The computer-accessible storage media of claim 9, and wherein the program code is further configured to cause the processor to:
prompt a user for one of a normal imaging input or a mirror imaging input; and
determine the mirror imaging status in accordance with the input.

12. The computer-accessible storage media of claim 9, and wherein the program code is further configured to cause the processor to:
detect an automatic mirror imaging designation associated with the electronic document file; and
determine the mirror imaging status in accordance with detecting the automatic mirror imaging designation.

13. The computer-accessible storage media of claim 9, and wherein the program code is further configured such that deriving the electronic mirror image includes transposing imaging information within the electronic document file about a predetermined line of symmetry.

14. An imaging apparatus, comprising:
an imaging engine configured to form images on a sheet media; and
a controller coupled in controlling relationship with the imaging engine, the controller including a processor and a computer-accessible storage media, the computer-accessible storage media including an executable program code, the program code configured to cause the processor to:
detect a transparency media designation associated with an electronic document file;
determine a mirror imaging status in response to detecting the transparency media designation;
derive an electronic mirror image of the electronic document file in accordance with the status; and
control the imaging engine to form an image on a transparency sheet media in accordance with the electronic mirror image.

15. The apparatus of claim 14, and wherein the executable program code is further configured to cause a processor to receive the electronic document file from a user computer.

16. The apparatus of claim 14, and wherein the executable program code is further configured to cause the processor to receive the electronic document file from an optical scanner.

17. The apparatus of claim 14, and wherein the program code is further configured to:
detect an automatic mirror imaging designation associated with the electronic document file; and
determine the mirror imaging status in accordance with the detecting the automatic mirror imaging designation.

18. The apparatus of claim 14, and wherein the program code is further configured to:
prompt a user for one of a normal imaging input or a mirror imaging input; and
determine the mirror imaging status in accordance with the input.

19. The apparatus of claim 14, and wherein the computer-accessible storage media includes one of a compact disk, a magnetic disk, or a solid-state memory.

20. The apparatus of claim 14, and wherein the imaging engine is defined by one of a laser imaging engine, an inkjet imaging engine, or a thermal imaging engine.

21. A system, comprising:
a user computer configured to generate an electronic document file;
an imaging apparatus coupled to the user computer and configured to form mirror images on a side of a transparency sheet media in correspondence to the electronic document file, thus defining a mirror-imaged media; and
an overhead projector configured to support the mirror-imaged media with the imaged side in contact with the overhead projector, the overhead projector further configured to viewably project the mirror images in proper viewing orientation onto a surface.

22. The system of claim 21, and wherein:
the user computer is further configured to selectively derive an electronic mirror image corresponding to the electronic document file in response to a designation; and
the imaging apparatus is further configured to form the mirror images on the transparency sheet media using the electronic mirror image.

23. The system of claim 22, and wherein the user computer includes a driver configured to cause the user computer to selectively derive the electronic mirror image corresponding to the electronic document file in response to the designation.

24. The system of claim 21, and wherein the imaging apparatus is further configured to:
derive an electronic mirror image corresponding to the electronic document file in response to a designation; and
form the mirror images on the transparency sheet media using the electronic mirror image.

25. The system of claim 24, and wherein the imaging apparatus includes a program code configured to cause the imaging apparatus to derive the electronic mirror image corresponding to the electronic document file in response to the designation.

26. An image projecting system, comprising:
means for generating an electronic document file;
means for deriving an electronic mirror image corresponding to the electronic document file;
means for forming mirror images on a side of a transparency sheet media in accordance with the electronic mirror image; and
projecting means for supporting the imaged side of the transparency sheet media in contact with the projecting means and viewably projecting the mirror images in proper viewing orientation onto a surface.
